(19) United States
(12) Patent Application Publication
(10) Pub. No.: US 2024/0194401 A1
(43) Pub. Date: Jun. 13, 2024

(54) METHOD OF MAKING AN INDUCTOR

(71) Applicant: MAX ECHO TECHNOLOGY CORPORATION, Taichung City (TW)

(72) Inventors: Kuo-Fong LIU, Taichung (TW); Chun-Cheng HUANG, Taichung City (TW)

(21) Appl. No.: 18/532,033

(22) Filed: Dec. 7, 2023

(30) Foreign Application Priority Data
Dec. 13, 2022 (TW) 111147796

(51) Int. Cl. H01F 41/02; H01F 41/00

(52) U.S. Cl. CPC H01F 41/0246; H01F 41/005

(57) ABSTRACT

The method for making the inductor includes coiling a enameled wire around a main section of a magnetic core and fixing two wire ends of the enameled wire on two end sections of the magnetic core, the two wire ends of the enameled wire being opposite to each other, the end sections being located at two opposite ends of the main section; putting the magnetic core coiled with the enameled wire into a container, filling the container with a magnetic powder material, and pressing to form semi-finished product having a first end, and a second end that is opposite to the first end; abrading the first and second ends of the semi-finished product until the wire ends are partially exposed; and performing a plating treatment to form two electrodes that are electrically connected to the two wire ends on the first and second ends.

### CROSS-REFERENCE TO RELATED APPLICATION

This application claims priority to Taiwanese Invention Patent Application No. 111147796, filed on Dec. 13, 2022, and incorporated by reference herein in its entirety.

### FIELD

The disclosure relates to a method, and more particularly to a method for making an inductor.

### BACKGROUND

Referring to FIG. 1, a conventional thin-type inductor as disclosed in Taiwan Utility Model Patent No. M598510 U includes an inductor main body 11, and two silver-coated ends 12 respectively disposed on two opposite sides of the inductor main body 11. A vertically wound coil 13 is located internally of the inductor main body 11. The coil 13 has two connecting ends 131 that are respectively connected to the two silver-coated ends 12. The conventional thin-type inductor is soldered to a surface of a PCB board.

The inductor main body 11 is formed by being shaped in a mold (not shown) through pressing. Magnetic powder is filled inside the mold to cover the coil 13. However, because the coil 13 is vertically wound, the number of windings in the coil 13 contributes to total height of the conventional thin-type inductor which must be relatively low so as to suit various applications. Additionally, the coil 13 is unsupported mechanically, and may deform when being pressed in the mold, thereby decreasing production yields.

### SUMMARY

Therefore, an object of the disclosure is to provide a method for making an inductor that can alleviate at least one of the drawbacks of the prior art.

According to the disclosure, the method for making the inductor includes steps of: a) coiling an enameled wire around a main section of a magnetic core and fixing two wire ends of the enameled wire respectively on two end sections of the magnetic core, the two wire ends of the enameled wire being opposite to each other, the main section extending in an extending direction, the two end sections being respectively located at two opposite ends of the main section and being space apart from each other in the extending direction; b) putting the magnetic core coiled with the enameled wire into a container, filling the container with a magnetic powder material, and pressing the magnetic powder material with the magnetic core and the coiled enameled wire in the container to form semi-finished product having a first end that is closer to one of the end sections, and a second end that is opposite to the first end in the extending direction and that is closer to the other one of the end sections; c) abrading the first end and the second end of the semi-finished product until the two wire ends are partially exposed; and d) subjecting the semi-finished product to a plating treatment so as to respectively form two electrodes on the first end and the second end, the two electrodes being respectively electrically connected to the two wire ends.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic cross-sectional view showing a conventional thin-type conductor disclosed in Taiwan Utility Model Patent No. M598510 U.

FIG. 2 is a flow chart illustrating steps of a method for making an inductor according to an embodiment of the present disclosure.

FIG. 3 is a perspective view illustrating an enameled wire coiled on a main section of a magnetic core.

FIG. 4 is a schematic side view illustrating two wire ends of the enameled wire fixed on two end sections of the magnetic core.

FIGS. 5 to 7 are schematic cross-sectional and perspective views showing consecutive procedures for forming a semi-finished product.

FIG. 8 is a schematic perspective view showing semi-finished products positioned by a jig.

FIGS. 9 and 10 are schematic cross-sectional views showing the semi-finished product being abraded.

FIG. 11 is a schematic view illustrating a barrel plating treatment performed on semi-finished products.

FIG. 12 is a perspective view illustrating an inductor made from the method according to the present disclosure.

FIG. 13 is a fragmentary cross-sectional view illustrating the inductor.

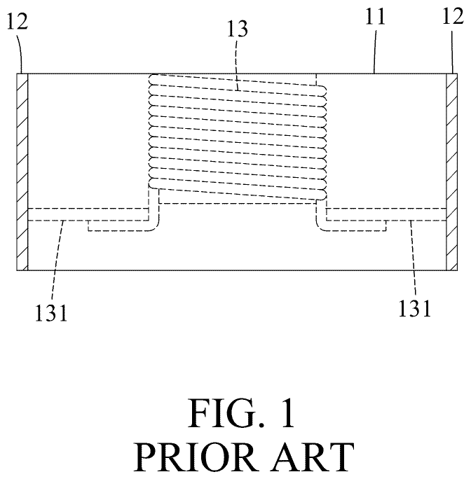

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

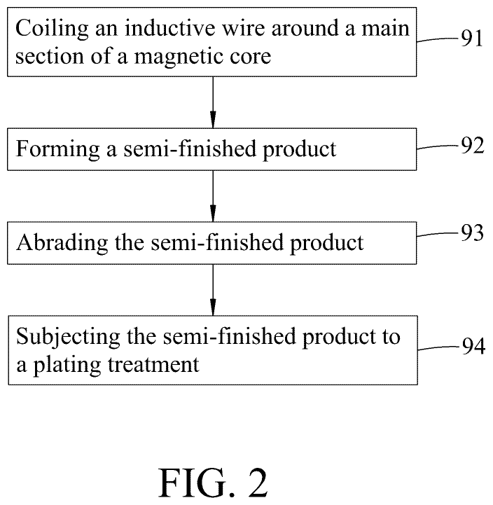

Referring to FIG. 2, a method for making an inductor 2 according to an embodiment of this disclosure includes steps 91 to 94.

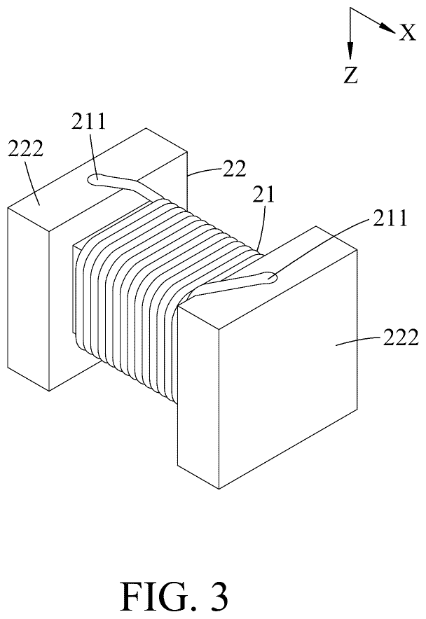

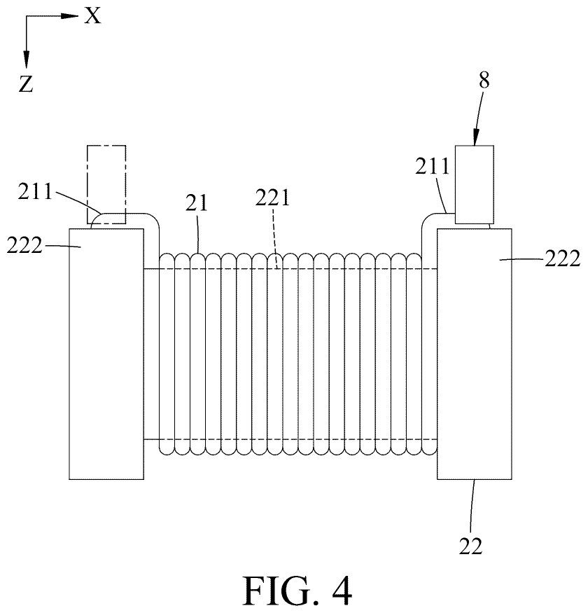

Referring to FIGS. 3 and 4, in the step 91, an enameled wire 21 is coiled around a main section 221 of a magnetic core 22 and two wire ends 211 of the enameled wire 21 are respectively fixed on two end sections 222 of the magnetic core 22. The two wire ends 211 of the enameled wire 21 are opposite to each other. The main section 221 extends in an extending direction (X). The two end sections 222 are respectively located at two opposite ends of the main section 221 and are spaced apart from each other in the extending direction (X). In this embodiment, the enameled wire 21 is an electrically conductive wire coated with a very thin layer of insulation, and the magnetic core 22 is made of an iron oxide material, a magnetic ceramic material, or a chromium-iron silicon alloy material. Additionally, the two wire ends 211 of the enameled wire 21 are fixed on the end sections 222 of the magnetic core 22 via hot pressing. In some embodiments, the two wire ends 211 of the enameled wire 21 are soldered on the end sections 222 of the magnetic core 22 using a soldering iron 8.

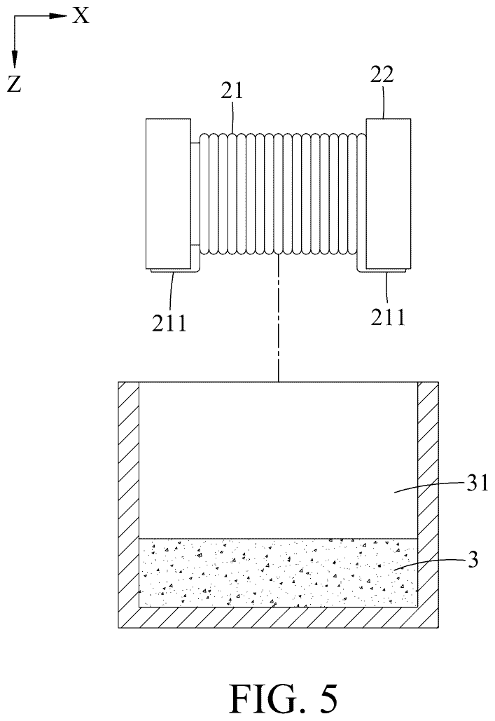

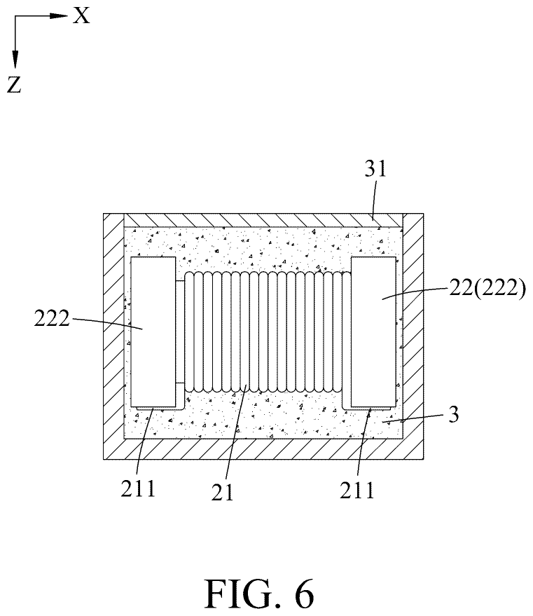

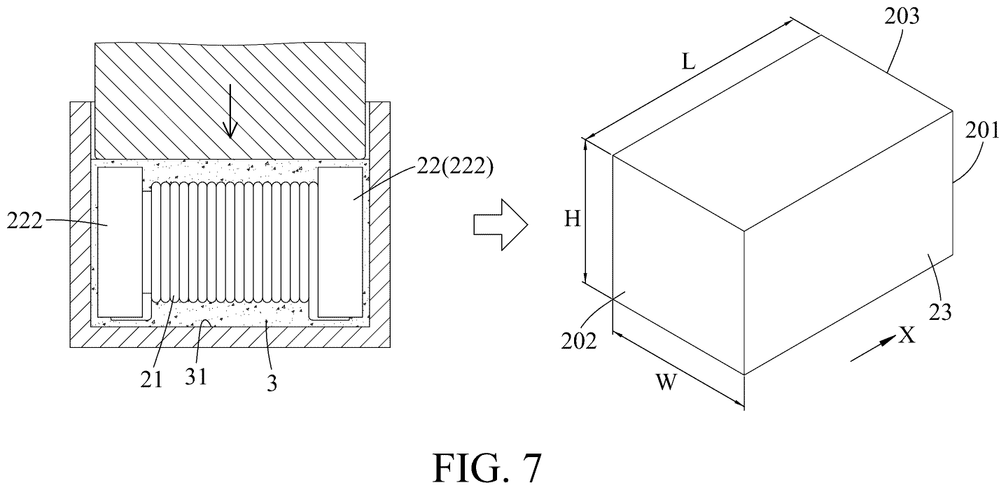

In the step 92, referring to FIGS. 5 and 6, the magnetic core 22 coiled with the enameled wire 21 is put into a container 31, then the container 31 is filled with a magnetic powder material 3, and the magnetic powder material 3 is pressed with the magnetic core 22 and the coiled enameled wire 21 in the container 31 so as to form a semi-finished product 201 (see FIG. 7). In some embodiments, before pressing the magnetic powder material 3 with the magnetic core 22 and the coiled enameled wire 21, a portion of the magnetic powder material 3 is first partially filled into the container 31, and then the magnetic core 22 coiled with the enameled wire 21 is put on the portion of the magnetic powder material 3 in the container 31 by lowering the magnetic core 22 into the container 31 vertically in a (Z) direction that is perpendicular to the extending direction (X). This is then followed by filling another portion of the magnetic powder material 3 into the container 31 to cover the magnetic core 22 coiled with the enameled wire 21. In some embodiments, the magnetic powder material 3 is one of an iron oxide material, a magnetic ceramic material, and a chromium-iron-silicon alloy material. In some embodiments, the magnetic powder material 3 is pressed with the magnetic core 22 and the coiled enameled wire 21 via hot pressing to form the semi-finished product 201. In the semi-finished product 201, the magnetic core 22 and the coiled enameled wire 21 are covered with a magnetic body 23.

The semi-finished product 201 has a first end 202 that is closer to one of the end sections 222, and a second end 203 that is opposite to the first end 202 in the extending direction (X) and that is closer to the other one of the end sections 222. The semi-finished product 201 has a length (L) along the extending direction (X), a width (W) that is perpendicular to the length (L), and a height (H) that is perpendicular to the length (L) and the width (W).

In this embodiment, the magnetic core 22 coiled with the enameled wire 21 is put into the container 31 horizontally (length (L) side down); however, in other embodiments, the magnetic core 22 coiled with the enameled wire 21 may be put into the container 31 vertically (width (W) side down).

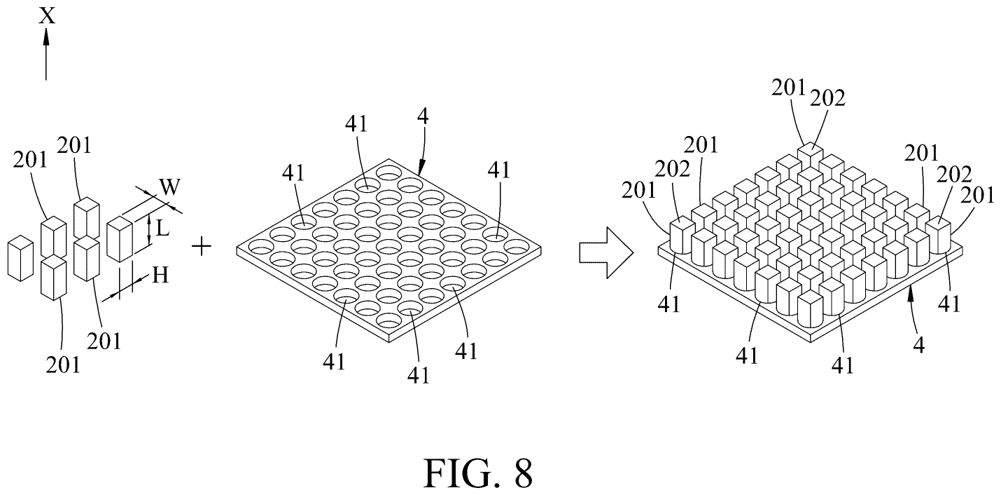

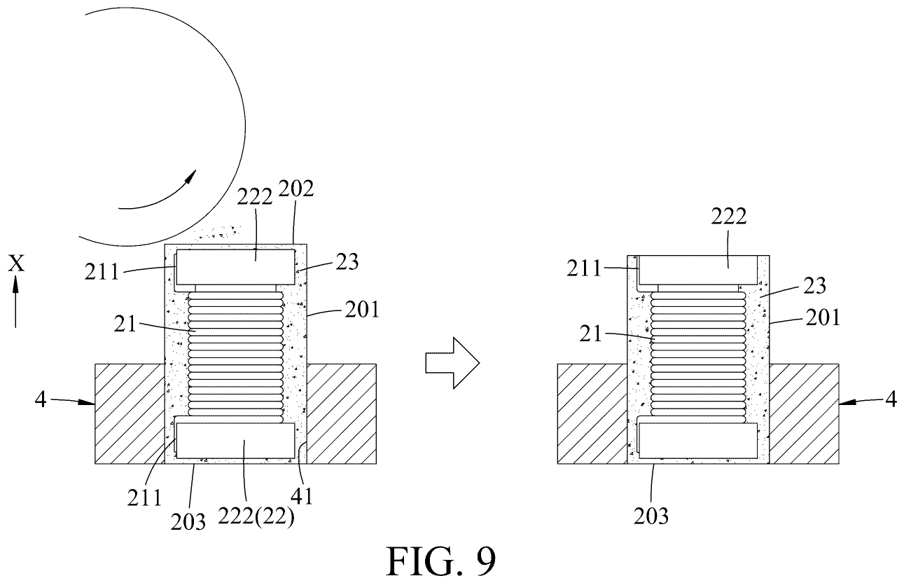

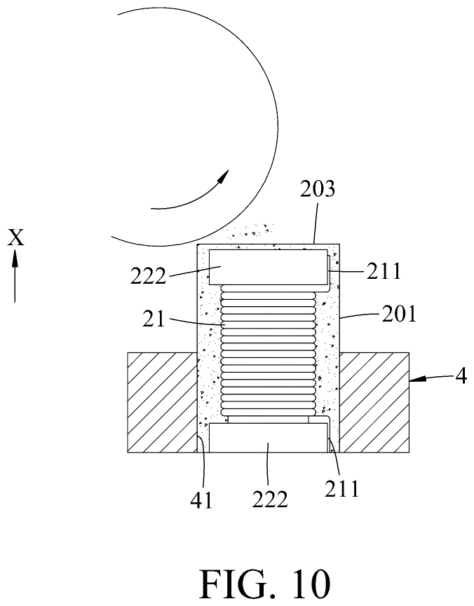

Referring back to FIG. 2, in the step 93, the semi-finished product 201 is abraded. In preparation for abrading, the semi-finished product 201 is positioned in at least one opening 41 of a jig 4 in a way that the first end 202 is exposed from the at least one opening 41. Referring to FIGS. 9 and 10, the first end 202 and the second end 203 of the semi-finished product 201 are abraded until the two wire ends 211 are partially exposed. Referring to FIG. 8, in this embodiment, the jig 4 includes multiple openings 41 that are spaced apart from each other, and there are multiple semi-finished products 201 that are positioned in the openings 41 of the jig 4. In this embodiment, each of the openings 41 is a circular hole with a diameter that is smaller than the length (L) of the semi-finished products 201, and slightly larger than the width (W) and the height (H) of the semi-finished products 201 (see FIG. 8). More specifically, the diameter of the openings 41 is substantially equal to the length of the hypotenuse of a triangle formed between the width (W) and the height (H) of the semi-finished products 201 plus an extra 0.05 mm. In this embodiment, the semi-finished products 201 are respectively positioned in the openings 41 of the jig 4 via vibration so that the first ends 202 of the semi-finished products 201 are each exposed from a respective one of the openings 41 (protrudes through the respective opening) of the jig 4, the positioning of the first ends 202 are stabilized due to the dimensions of the openings 41 and the semi-finished products 201 as specified above.

Referring to FIG. 9, in this embodiment, the first ends 202 of the semi-finished products 201 are abraded to expose one of the two wire ends 211 of the enameled wire 21 in each of the semi-finished products 201. Referring to FIG. 10, the jig 4 is then flipped with the semi-finished products 201 so as to expose the second ends 203 of the semi-finished products 201 from the openings 41. The second ends 203 of the semi-finished products 201 are abraded to expose the other one of the wire ends 211 of the enameled wire 21 in each semi-finished product 201.

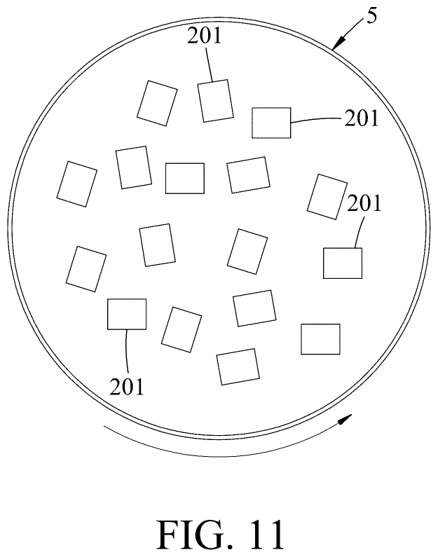

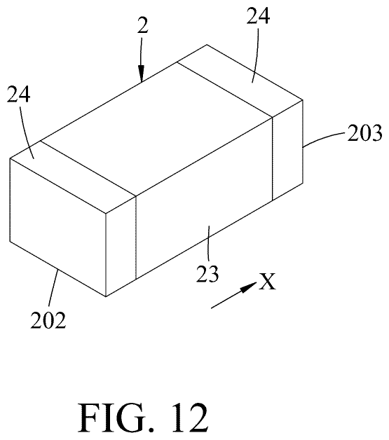

Referring to FIGS. 11 and 12, in the step 94, each semi-finished product 201 is subjected to a plating treatment so as to respectively form two electrodes 24 on the first end 202 and the second end 203 of the semi-finished product 201. More specifically, the first ends 202 and the second ends 203 of the semi-finished products 201 are first coated with a layer of silver, the plating treatment is then performed by barrel plating within a barrel 5 to form an electrode 24 on each of the first and second ends 202, 203 of each semi-finished product 201, thereby forming finished inductors 2. It should be noted, that in other embodiments, a vacuum plating treatment may be used to form the electrodes 24; however, this is not a limitation of the disclosure.

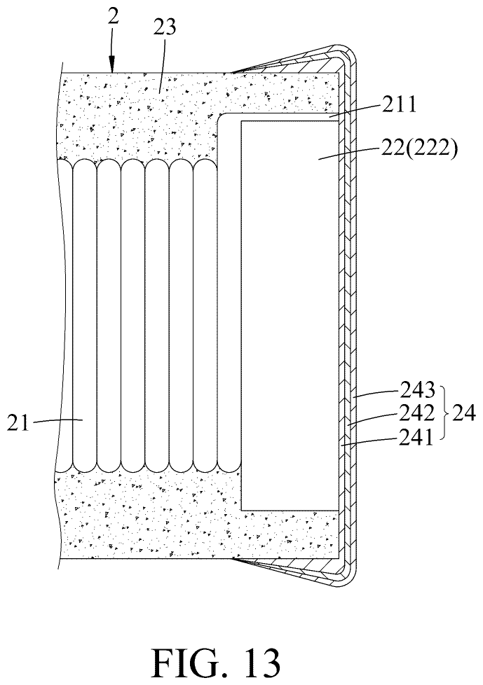

Referring to FIG. 13, in this embodiment, the two electrodes 24 of each semi-finished product 201 are respectively electrically connected to the two wire ends 211. More specifically, each electrode 24 covers one of the end sections 222 and the wire end 211 that is fixed to that end section 222. In some embodiments, the electrodes 24 has a silver layer 241, a nickel layer 242, and a tin layer 243; however, in other embodiments, the electrode 24 may be composed from other plated layers, the amount and type of plating and layers are not limitations of the present disclosure.

In summary of the above, the method for making the inductor according to the present disclosure has the following advantages.

1. The enameled wire 21 is coiled around the main section 221 which extends in the extending direction (X), and the end sections 222 are spaced apart from each other in the extending direction (X). In the case where the inductor 2 requires an increase in the number of windings on the magnetic core 22, the height of the inductor 2 may remain the same which is conducive for applications requiring a thin-type inductor.

2. The enameled wire 21 is supported by the main section 221 of the magnetic core 22, and the two wire ends 211 of the enameled wire 21 are respectively fixed on the two end sections 222 of the magnetic core 22. These design features prevents deformation of the enameled wires 21 or dislocation of the wire ends 211 when forming and abrading the semi-finished product 201 which increases manufacturing yield.

3. By having horizontal coiling, parasitic capacitance will only occur at the end sections 222, between each of the end sections 222 and a nearest winding of the enameled wire 21 on the main section 221 of the magnetic core 22. In comparison to conventional vertical type inductors such as the vertically wound coil where each winding of the vertically wound coil would generate parasitic capacitance with the two silver-coated ends, the inductor 2 of the present disclosure has reduced parasitic capacitance with increased self-resonant frequency.

4. The electrodes 24 are formed via a plating treatment on the first and the second end 24 which increases contact area of the inductor 2 for electrical connections, and decreases the chance of poor electrical contact occurring, thereby increasing reliability of the inductor 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for making an inductor comprising steps of:
a) coiling an enameled wire around a main section of a magnetic core and fixing two wire ends of the enameled wire respectively on two end sections of the magnetic core, the two wire ends of the enameled wire being opposite to each other, the main section extending in an extending direction, the two end sections being respectively located at two opposite ends of the main section and being spaced apart from each other in the extending direction;
b) putting the magnetic core coiled with the enameled wire into a container, filling the container with a magnetic powder material, and pressing the magnetic powder material with the magnetic core and the coiled enameled wire in the container to form a semi-finished product having a first end that is closer to one of the end sections, and a second end that is opposite to the first end in the extending direction and that is closer to the other one of the end sections;
c) abrading the first end and the second end of the semi-finished product until the two wire ends are partially exposed; and
d) subjecting the semi-finished product to a plating treatment so as to respectively form two electrodes on the first end and the second end, the two electrodes being respectively electrically connected to the two wire ends.

2. The method for making the inductor as claimed in claim 1, wherein in step a), the two wire ends of the enameled wire are fixed on the end sections via hot pressing.

3. The method for making the inductor as claimed in claim 1, wherein in step b), before pressing the magnetic powder material with the magnetic core and the coiled enameled wire, a portion of the magnetic powder material is first partially filled into the container, and then the magnetic core coiled with the enameled wire is put on the portion of the magnetic powder material in the container, followed by filling another portion of the magnetic powder material into the container to cover the magnetic core coiled with the enameled wire.

4. The method for making the inductor as claimed in claim 1, wherein in step b), the magnetic powder material is pressed with the magnetic core and the coiled enameled wire via hot pressing to form the semi-finished product.

5. The method for making the inductor as claimed in claim 1, wherein step c) includes:
positioning the semi-finished product in at least one opening of a jig in a way that the first end is exposed from the at least one opening;
abrading the first end of the semi-finished product to expose one of the two wire ends;
flipping the jig with the semi-finished product so as to expose the second end from the at least one opening; and
abrading the second end of the semi-finished product to expose another one of the two wire ends.

6. The method for making the inductor as claimed in claim 5, wherein in step c), the semi-finished product is position in the at least one opening of the jig via vibration.

7. The method for making the inductor as claimed in claim 6, wherein the at least one opening includes multiple openings that are spaced apart from each other.

8. The method for making the inductor as claimed in claim 1, wherein in step d), the plating treatment is performed by barrel plating.

9. The method for making the inductor as claimed in claim 1, wherein each of the electrodes has a silver layer, a nickel layer, and a tin layer.

10. The method for making the inductor as claimed in claim 1, wherein the magnetic powder material is one of an iron oxide material, a magnetic ceramic material, and a chromium-iron-silicon material.
